(19) United States
(12) Patent Application Publication
(10) Pub. No.: US 2015/0218500 A1
(43) Pub. Date: Aug. 6, 2015

(54) CITRON RICE WINE AND ITS MANUFACTURING METHOD

(71) Applicant: Hong Jun KIM, Seoul (KR)

(72) Inventor: Hong Jun KIM, Seoul (KR)

(21) Appl. No.: 14/596,871

(22) Filed: Jan. 14, 2015

(30) Foreign Application Priority Data
Feb. 5, 2014 (KR) 10-2014-0013253

(51) Int. Cl. C12G 1/00

(52) U.S. Cl. CPC C12G 1/005

(57) ABSTRACT

A citron rice wine and its manufacturing method includes a citron sugar pickling step; a citron extract finishing step; a citron crude liquid mixing step; a rice wine mixing step; a citron skin removing step; a vacuum ripening step; and a rice wine extracting step. There is further provided a tapioca mixing step wherein a tapioca citron rice wine is finished using the citron rice wine which has been manufactured in the rice wine extracting step. With respect to the extracted citron rice wine, the following steps are performed in a base finishing step: a citron rice wine precipitating step; a refined rice wine extracting step; a distilled liquor mixing step; and a carbonated water mixing step. In a cocktail finishing step, there are provided the steps of a cold base finishing step for cooling the base, an apple mint adding step; a base adding and mixing step; a tapioca mixing step; a carbonated water adding step; and a lime/lemon mixing step.

### CROSS REFERENCE

The present application claims the benefit of Korean Patent Application No. 10-2014-0013253 filed in the Korean Intellectual Property Office on 5 Feb. 2014, the entire contents of which are incorporated herein by reference.

### BACKGROUND OF THE INVENTION

The present invention relates to a citron rice wine and its manufacturing method, and a citron rice wine and its manufacturing method wherein it is possible to manufacture a variety of alcoholic liquors such as cocktail, a citron rice wine, etc. in such a way to mix and ripen a citron extract and a rice wine and to add tapioca, apple mint, carbonated water, distilled alcoholic liquor, etc.

A rice wine is a representative of Korean traditional fermented alcoholic liquors, wherein rice is used as a principle component. Rice wines with different tastes and flavors may be manufactured based on the kinds of added grains or additives which are generally used when manufacturing rice wine. In order to add a variety of flavors and tastes to a typical rice wine, as described in the Korean Patent Application No. 10-2010-0135000 entitled “citron rice wine and its manufacturing method” and the Korean Patent Application No. 10-2009-0102644 entitled “fruit rice wine and its manufacturing method”, the fruit rice wine is manufactured by mixing citron or fruit extract. The above mentioned manufacturing method has a problem in that a fruit fermented liquid or extract is simply added to a rice wine so as to add a predetermined taste, so it is impossible to obtain a deep fruit flavor since the taste of the rice wine and the flavor of the added fruit are not chemically combined. More specifically speaking, since a fruit juice and a rice wine are separated and ripen, so a combination of the taste and flavor lacks. Furthermore, the above mentioned methods fail to disclose any methods for manufacturing a variety of alcoholic liquors. As compared with the above methods, the present invention is directed to effectively mixing a rice wine and a fruit juice fermented liquid by providing a process wherein a fruit juice and a rice wine are mixed and integrally ripen, and it is possible to manufacture a variety of alcoholic liquors using the above fruit rice wine.

### SUMMARY OF THE INVENTION

Accordingly, the present invention is directed to a citron rice wine and its manufacturing method. it is an object of the present invention to provide a citron rice wine and its manufacturing method which are characterized in that a preference may be enhanced since a swallowing taste is soft, and aftertaste is clean, in such a way that the tastes and flavors of a citron and a rice wine are well combined, and a variety of alcoholic liquors may be manufactured using such features.

To achieve the above objects, there are provided a citron rice wine and its manufacturing method which are characterized in that a variety of alcoholic liquors including cocktail may be manufactured in such a way that a citron extract and a rice wine are mixed and ripen together under vacuum environment for 2˜36 hours for thereby manufacturing a citron rice wine wherein the tastes and flavors of the citron and the rice wine are well combined, and tapioca, refined rice wine, distilled alcoholic liquor, carbonated liquor, etc. are mixed at a predetermined ratio to the thusly manufactured rice wine.

The present invention is directed to a citron rice wine and its manufacturing method which are advantageous in that the storage period which is one of the disadvantages of the rice wine product may be prolonged, which results in a good storage performance, and a fruit fermented liquid such as a citron, etc. is added to a traditional rice fermented alcoholic liquor and is ripen, so it is possible to change flavors depending on the kinds of added fruit, and since a fruit flavor and a fruit taste are added, a swallowing taste is soft, and aftertaste is clean when a customer drinks.

In addition, the present invention is characterized in that it is possible to manufacture a variety of alcoholic liquors such as cocktail, etc. in such a way that a citron rice wine is precipitated to manufacture a refined rice wine, and tapioca, carbonated water, distilled alcoholic liquor, etc. are added to the refined rice wine.

Furthermore, the present invention is advantageous in that a souring taste and freshness taste of a rice wine may be adjusted by changing the ripening period.

### BRIEF DESCRIPTION OF DRAWING

FIG. 1 is a flow chart of a method for manufacturing a citron rice wine according to the present invention.

### DETAILED DESCRIPTION OF THE INVENTION

The present invention is directed to a citron rice wine and its manufacturing method. The method basically includes a citron sugar pickling step; a citron extract finishing step; a citron crude liquid mixing step; a rice wine mixing step; a citron skin removing step; a vacuum ripening step; and a rice wine extracting step. There is further provided a tapioca mixing step wherein a tapioca citron rice wine is finished using the citron rice wine which has been manufactured in the rice wine extracting step. With respect to the extracted citron rice wine, the following steps are performed in a base finishing step: a citron rice wine precipitating step; a refined rice wine extracting step; a distilled liquor mixing step; and a carbonated water mixing step. In a cocktail finishing step, there are provided the steps of a cold base finishing step for cooling the base, an apple mint adding step; a base adding and mixing step; a tapioca mixing step; a carbonated water adding step; and a lime/lemon mixing step.

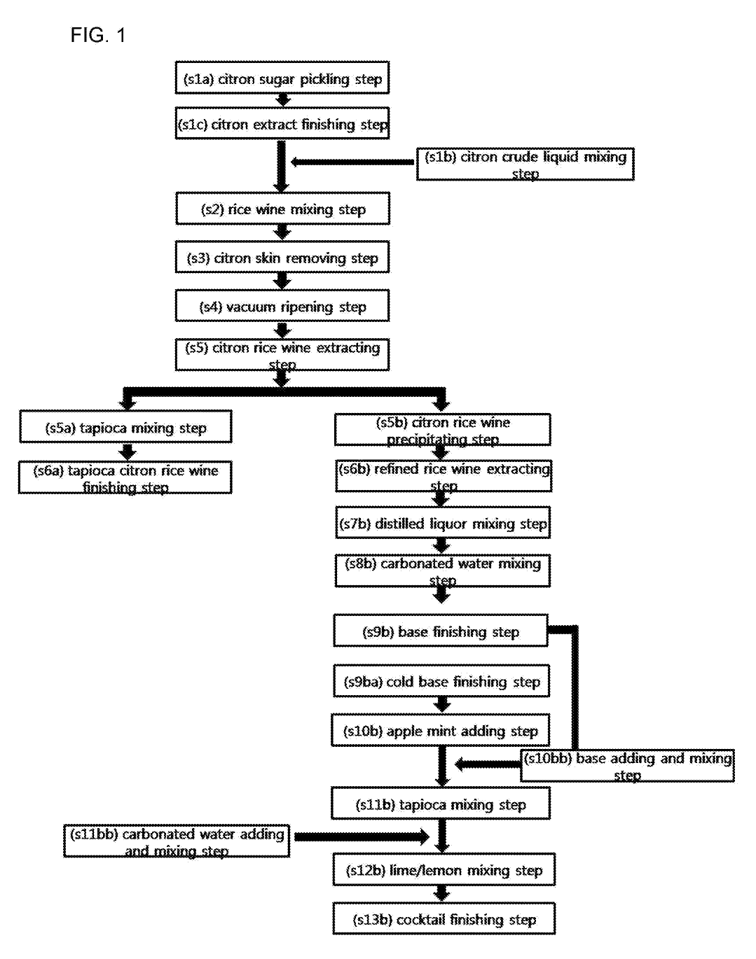

The above procedures will be described in more details with reference to the flow chart in FIG. 1.

The present invention includes a citron extract finishing step (s1c) wherein a citron sugar mixture manufactured in a citron sugar pickling step (s1a) for mixing at a ratio of 1:1 a citron whose skin is not removed and a superfine sugar is mixed at a ratio of 6.5:3.5 with an additional additive which is manufactured by mixing at a ratio of 7.1:2.8:14.2:75.7 a fructose, sodium, carbohydrate, and vitamin C. There are a citron crude liquid mixing step (s1b) for manufacturing a citron essence in such a way to mix the above citron extract with 100% of a citron crude liquid, and a citron skin removing step for removing the skin of the citron after the process of the rice wine mixing step (s2) for mixing at a ratio of 7˜16:84-93 the citron essence and 6% alcohol content of the rice wine. In more details, the citron extract, the citron crude liquid and 6% alcohol content of the rice wine are mixed at a ratio of 5˜10:2˜6:84˜93. As a result of the preference test performed with respect to 100 customers, the preference was highest when the citron essence and the rice wine were mixed at a ratio of 7˜16:84˜93.

TABLE 1

| Classification | Mixing ratio | | | |
|---|---|---|---|---|
| Ratio of rice | 60~70 | 71~83 | 84~93 | 94~99 |
| wine (%) | | | | |
| Citron essence (%) | 30~40 | 17~29 | 7~16 | 1~6 |
| preference (number | 0 | 8 | 85 | 7 |
| of customers) | | | | |

The vacuum ripening step (s4) is performed after the citron skin removing step (s3). The level of the fermentation is determined based on the ripening period where the fermentation proceeds, and carbonic acid itself generates. Generally speaking, 2˜36 hours vacuum ripening is necessary so as to extract the citron rice wine, and the citron rice wine is manufactured through the citron rice wine extracting step. The citron rice wine manufactured through the citron rice wine extracting step (s5) may be used as a basic component when manufacturing cocktail or tapioca citron rice wine.

First, in order to manufacture the tapioca citron rice wine, the tapioca citron rice wine is finished through the tapioca mixing step (s5a) wherein tapioca is mixed at a ratio of 80˜98:2˜20 with the citron rice wine which has been manufactured in the citron rice wine extracting step (s5).

Second, in order to manufacture cocktail, the present invention is characterized in that floating impurities may be eliminated through the refined rice wine extracting step (s6b) wherein refined rice wine is extracted after the citron rice wine precipitating step (s5b) is performed, wherein floating impurities are eliminated by precipitating the finished citron rice wine for 48˜96 hour in the citron rice wine extracting step (s5), so thick taste of the rice wine may be minimally reduced. There is a base finishing step (s9b) for manufacturing the base of the cocktail through the distilled liquor mixing step (s7b) and the carbonated water mixing step (s8b) wherein lemon or lime or apple mint is mixed at a ratio of 30˜35:15˜20:47˜51:1.2˜4.3 so as to add 25% alcohol content of distilled liquid, carbonated water and other tastes and flavor to the rice wine which is manufactured in the rice wine extracting step (s6b). In the base finishing step (s9b) wherein an apple mint may be added (s10ba) to a slush type cold base which is finished through the cold base finishing step (s9ba) wherein part of the finished base is cooled, and the cooled base is crushed to manufacture a slush type cold base, the cocktail (s13b) is manufactured through any one of the tapioca mixing step (s11b) for mixing tapioca, the carbonated water adding and mixing step (s11bb) for additionally mixing so as to adjust the amount of carbonic acid of the cocktail and the lime/lemon mixing step (s12b) for adjusting acidity of the cocktail.

Here, the previous steps or following steps of the distilled liquor mixing step (s7b) and the carbonated water mixing step (s8b) may change irrespective of the flow chart in FIG. 1.

In addition, the cocktail may be manufactured through at least one of the apple mint flavor adding (s10b), the base adding and mixing step (s10bb), the tapioca mixing step (s11b), the carbonated water adding and mixing step (s11bb) and the line/lemon mixing step (s12b), wherein at least one of the base manufactured in the base finishing step (s9b), the carbonated water, the apple mint, the tapioca, the carbonated water, the lime and the lemon are added, depending on preference, to a slush type of the cold base finished in the cold base finishing step (s9ba). The adding sequence may change when mixing or adding at least one of the apple mint adding step (s10b), the base adding and mixing step (s10bb), the tapioca mixing step (s11b), the carbonated water adding and mixing step (s11bb) and the lime/lemon mixing step (s12b).

It is obvious that the way where a variety of fruit tastes and flavors may be added by the kinds of fruits in such a way that a citron or other various fruits instead of the citron may be ripened together with the rice wine depending on preference may be easily implemented by a person having ordinary skill in the art.

1. A citron rice wine manufacturing method, comprising:
a citron sugar pickling step (s1a) wherein a citron whose skin is not removed and a white sugar are mixed at a ratio of 1:1 for thereby manufacturing a citron sugar mixture;
a citron extract finishing step (s1c) wherein a citron extract is manufactured in such a way to mix the above manufactured citron sugar mixture and an additional additive agent formed of fructose, sodium, carbohydrate and vitamin C, which are mixed at a ratio of 7.1:2.8:14.2:75.7, are mixed at a ratio of 6.5:3.5;
a citron crude liquid mixing step (s1b) wherein a citron essence is manufactured by mixing the above manufactured citron extract and a 100% citron crude liquid;
a rice wine mixing step (s2) wherein the above manufactured citron essence and a rice wind of a 6% alcohol content are mixed at a ratio of 7˜16:84˜93;
a citron skin removing step (s3) wherein the citron skin is removed from the citron essence mixed with the rice wine;
a vacuum ripening step (s4) wherein after the citron skin removing step, the essence of the citron whose skin is removed and a rice wine mixture of a 6% alcohol content are ripened for 2˜36 hours; and
a citron rice wine extracting step which is performed after the vacuum ripening step.

2. The method of claim 1, further comprising:
a tapioca mixing step (s5a) wherein a tapioca is mixed at a ratio of 80˜98:2˜20 with the citron rice wine manufactured in the citron rice wine extracting step, for thereby manufacturing a tapioca rice wine.

3. The method of claim 1, further comprising:
a citron rice wine precipitating step (s5b) wherein floating impurities are sunk by precipitating for 48˜96 hours the citron rice wine which is manufactured in the citron rice wine extracting step (s5);
a refined rice wine extracting step (s6b) wherein a refined rice wine is extracted after the floating impurities are sunk; and
a distilled liquid and carbonated water mixing step (s7b, s8b) wherein a base is manufactured by mixing the refined liquor extracted in the refined liquor extracting step with distilled liquor and carbonated water irrespective of their sequences, for thereby manufacturing a base.

4. The method of claim 1, further comprising:
a cold base finishing step (s9ba) wherein a slush type cold base is manufactured by cooling and crushing the base finished in the base finishing step (s9b); and
any one of an apple mint adding step (s10b), a base adding and mixing step (s10bb), a tapioca mixing step (s11b), a carbonated water adding and mixing step (s11bb) and a lime or lemon mixing step (s12b) so that a cocktail can be manufactured by additionally adding a base, a carbonated water, an apple mint, a tapioca, a carbonated water, or a lime or lemon to the slush type cold base which are manufactured through the apple mint adding step (s10b) and the base finishing step (s9b), for thereby manufacturing a cocktail.

5. A citron rice wine manufacturing method characterized in that a citron rice wine, a tapioca citron rice wine or a cocktail is manufactured by the manufacturing method of claim 1.

6. A citron rice wine manufacturing method characterized in that a citron rice wine, a tapioca citron rice wine or a cocktail is manufactured by the manufacturing method of claim 2.

7. A citron rice wine manufacturing method characterized in that a citron rice wine, a tapioca citron rice wine or a cocktail is manufactured by the manufacturing method of claim 3.

8. A citron rice wine manufacturing method characterized in that a citron rice wine, a tapioca citron rice wine or a cocktail is manufactured by the manufacturing method of claim 4.
